(19) United States
(12) Patent Application Publication
(10) Pub. No.: US 2021/0049841 A1
(43) Pub. Date: Feb. 18, 2021

(54) APPARATUS FOR DETERMINING DRIVING SITUATION OF VEHICLE AND CONTROL METHOD THEREOF

(71) Applicants: Hyundai Motor Company, Seoul (KR); Kia Motors Corporation, Seoul (KR)

(72) Inventors: Young Won Hur, Hwaseong-si (KR); Jinha Kim, Suwon-si (KR); Se Young Park, Suwon-si (KR)

(21) Appl. No.: 16/598,701

(22) Filed: Oct. 10, 2019

(30) Foreign Application Priority Data
Aug. 14, 2019 (KR) 10-2019-0099528

(51) Int. Cl. G07C 5/08; B60W 50/08; B60W 40/08; B60W 40/105

(52) U.S. Cl. CPC G07C 5/085; B60W 50/08; B60W 40/08; B60W 2540/12; B60W 2540/18; B60W 2540/10; B60W 40/105

(57) ABSTRACT

A vehicle includes: a camera configured to acquire a driving image of the vehicle; a control device; and a controller configured to output the driving image by reflecting driving information of the vehicle derived based on a control situation of the control device to the driving image acquired by the camera.

### CROSS-REFERENCE TO RELATED APPLICATION

This application is based on and claims priority to Korean Patent Application No. 10-2019-0099528, filed on Aug. 14, 2019 in the Korean Intellectual Property Office, the disclosure of which is incorporated herein by reference.

### TECHNICAL FIELD

The present disclosure relates to a vehicle for recording a driving image of the vehicle, a control method of the vehicle, and an image module.

### BACKGROUND

In recent years, a vehicle black box (a vehicle video recording device) has been commercialized and used to determine the cause of a traffic accident. Such a black box is installed inside a vehicle to record an image of an outside of the vehicle by capturing the image while the vehicle is moving or stopped.

The vehicle black box generally includes a front camera, a rear camera, and a processor for controlling the same. The controller may store driving image information transmitted from the front camera and the rear camera for a set time in a storage.

When the set time elapses, the controller transmits and stores the driving image information stored in a volatile memory to a storage memory.

Since an image module for the existing black box cannot acquire information of the vehicle smoothly, it is difficult to include the vehicle information in image processing of the black box. Therefore, it is difficult to determine the exact driving situation from the image or a video.

Therefore, researches to solve these problems are being actively conducted.

### SUMMARY

An aspect of the present disclosure is to provide a vehicle, a control method of the vehicle, and an image module, capable of smoothly determining a driving situation by providing a driving image including driving information of the vehicle.

In accordance with one aspect of the present disclosure, a vehicle includes: a camera configured to acquire a driving image of the vehicle; a control device; and a controller configured to output the driving image by reflecting driving information of the vehicle derived based on a control situation of the control device to the driving image acquired by the camera.

The control device is configured to acquire a plurality of driving elements of the vehicle, and the controller is configured to control to display driving information of the vehicle including at least one of the plurality of driving elements on the driving image based on a user's command input.

The control device includes a steering wheel, and the controller is configured to control to output the driving image including a rotation angle of the steering wheel.

The control device includes a pedal, and the controller is configured to control to output the driving image including a pedal effort of the pedal.

The controller is configured to output the driving image including a speed of the vehicle derived based on a wheel speed of the vehicle.

The controller is configured to output the driving image including an operation state such as a direction indication of the vehicle.

In accordance with another aspect of the present disclosure, a control method of a vehicle includes: acquiring a driving image of the vehicle; and outputting the driving image by reflecting driving information of the vehicle to the driving image.

The control method further includes: acquiring a plurality of driving elements of the vehicle; and determining at least one of the plurality of driving elements based on a user's command input.

The outputting includes controlling to output the driving image including a rotation angle of the steering wheel.

The outputting includes controlling to output the driving image including a pedal effort of the pedal.

The outputting includes controlling to output the driving image including a speed of the vehicle derived based on a wheel speed of the vehicle.

The outputting includes controlling to output the driving image including an operation state which includes a direction indication of the vehicle.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a control block diagram of a vehicle according to an exemplary embodiment of the present disclosure.

FIG. 2 is a diagram illustrating an operation of reflecting driving information in a vehicle driving image according to an exemplary embodiment of the present disclosure.

FIG. 3 is a diagram illustrating driving information of a vehicle reflected in a driving image of the vehicle according to an exemplary embodiment of the present disclosure.

FIGS. 4A, 4B, and 4C are diagrams illustrating operations of selecting driving information displayed on a driving image according to an exemplary embodiment of the present disclosure.

FIG. 5 is a flowchart according to an exemplary embodiment of the present disclosure.

### DETAILED DESCRIPTION

Like numerals refer to like elements throughout the specification. Not all elements of embodiments of the present disclosure will be described, and description of what are commonly known in the art or what overlap each other in the embodiments will be omitted. The terms as used throughout the specification, such as “˜part”, “˜module”, “˜member”, “˜block”, etc., may be implemented in software and/or hardware, and a plurality of “˜parts”, “˜modules”, “˜members”, or “˜blocks” may be implemented in a single element, or a single “˜part”, “˜module”, “˜member”, or “˜block” may include a plurality of elements.

It will be further understood that the term “connect” or its derivatives refer both to direct and indirect connection, and the indirect connection includes a connection over a wireless communication network.

It will be further understood that the terms “comprises” and/or “comprising,” when used in this specification, identify the presence of stated features, integers, steps, operations, elements, and/or components, but do not preclude the presence or addition of one or more other features, integers, steps, operations, elements, components, and/or groups thereof, unless the context clearly indicates otherwise.

In the specification, it will be understood that, when a member is referred to as being “on/under” another member, it can be directly on/under the other member, or one or more intervening members may also be present.

The terms including ordinal numbers like “first” and “second” may be used to explain various components, but the components are not limited by the terms. The terms are only for the purpose of distinguishing a component from another.

As used herein, the singular forms “a,” “an” and “the” are intended to include the plural forms as well, unless the context clearly indicates otherwise.

Reference numerals used for method steps are just used for convenience of explanation, but not to limit an order of the steps. Thus, unless the context clearly dictates otherwise, the written order may be practiced otherwise.

Hereinafter, the operating principles and embodiments of the disclosure will be described with reference to the accompanying drawings.

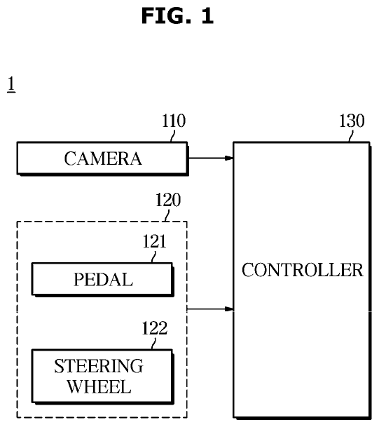

FIG. 1 is a control block diagram of a vehicle according to an exemplary embodiment of the present disclosure.

A vehicle 1 according to an exemplary embodiment may include a camera 110, a control device 120, and a controller 130.

The camera 110 may refer to a configuration for obtaining a driving image. The driving image includes a vehicle surrounding image, and may mean a black image used for analyzing an accident when an accident of the vehicle occurs. The camera 110 may be provided on front, rear, and lateral sides of the vehicle to acquire images.

The camera 110 installed on the vehicle may include a charge-coupled device (CCD) camera or a complementary metal-oxide semiconductor (CMOS) color image sensor. The CCD and the CMOS may refer to a sensor that converts light received through a lens of a camera into an electric signal. In detail, the CCD camera refers to an apparatus that converts an image into an electric signal using a charge-coupled device. In addition, a CMOS image sensor (CIS) refers to a low-consumption and low-power type image pickup device having a CMOS structure, and serves as an electronic film of a digital device. In general, the CCD has a sensitivity superior than that of the CIS and thus is widely used in the vehicle, but the present disclosure is not limited thereto.

The control device 120 may include a pedal 121 and a steering wheel 122 provided in the vehicle. Each pedal 121 and the steering wheel 122 may include a sensor for obtaining the movement information of each control device 120.

The controller 130 may reflect the driving information of the vehicle in the driving image acquired by the camera and output the same to a display. The controller 130 may be a processor, computer, microprocessor, etc. such as a Central Processing Unit (CPU), an Electronic Control Unit (ECU).The driving information may include pedal effort, vehicle speed, and the like. The controller 130 can also receive this information through the in-vehicle network.

Although not shown in FIG. 1, the display may be provided in the vehicle or may be provided separately from the vehicle. The display may be provided as a Cathode Ray Tube (CRT), Digital Light Processing (DLP) panel, Plasma Display Panel (PDP), Liquid Crystal Display (LCD) panel, Electro Luminescence (EL) panel, Electrophoretic Display (EPD) panel, Electrochromic Display (ECD) panel, Light Emitting Diode (LED) panel, or Organic Light Emitting Diode (OLED) panel, etc., but is not limited thereto.

The control device 120 may acquire a plurality of driving elements of the vehicle. The driving elements may include a pedal operation amount, a vehicle speed, and the like.

The controller 130 may control the display to display driving information of the vehicle including at least one of the plurality of driving elements on the driving image based on an user's command input through an input unit.

Although not shown in FIG. 1, the input unit may be provided in the vehicle, or may be provided separately from the vehicle together with the aforementioned display.

The input unit may include hardware devices such as buttons, switches, pedals, keyboards, mouse, track-balls, levers, handles and sticks for user input. In addition, the input unit may include a graphical user interface (GUI) such as a touch pad for user input, that is, a software device. The touch pad may be implemented as a touch screen panel (TSP) to form a layer structure with the display.

When the touch screen panel (TSP) forms a layer structure with the touch pad, the display may also be used as an input unit.

The control device 120 may include a steering wheel provided in the vehicle. The control device 120 may include a steering sensor that can obtain an angle at which a tire actually rotates with respect to a rotation angle of the steering wheel of the vehicle.

The controller 130 may control to output the driving image including the rotation angle of the steering wheel.

The controller 130 may control to output the driving image including the pedal effort.

The controller 130 may control to output the driving image including the speed of the vehicle derived based on a wheel speed of the vehicle. On the other hand, the controller 130 may derive the speed of the vehicle based on a wheel speed sensor provided in the vehicle. Detailed description thereof will be described later.

The controller 130 may be implemented in a memory (not shown) that stores data for an algorithm or a program that reproduces the algorithm for controlling the operation of components in the vehicle, and a processor (not shown) that performs the above-described operation using the data stored in the memory. In this case, the memory and the processor may be implemented as separate chips. Alternatively, the memory and the processor may be implemented in a single chip.

In addition, although not shown in FIG. 1, the vehicle may include a communication unit capable of communicating with a plurality of components provided in the vehicle. The communication unit may include one or more components that enable communication with an external device, for example, at least one of a short-range communication module, a wired communication module, and a wireless communication module.

The short-range communication module may include various short-range communication modules that may transmit and receive signals in a short distance using a wireless communication network, for example, a Bluetooth module, an infrared communication module, a radio frequency identification (RFID) communication module, a wireless local access network (WLAN) communication module, a near field communication (NFC) communication module, a Zigbee communication module, and the like.

The wired communication module may include not only various wired communication modules, such as a controller area network (CAN) communication module, a local area network (LAN) communication module, a wide area network (WAN) module, or a value added network (VAN) module, but also various cable communication modules, such as a universal serial bus (USB), a high definition multimedia interface (HDMI), a digital visual interface (DVI), a recommended standard 232 (RS-232), power line communication, or plain old telephone service (POTS).

The wireless communication module may include various wireless communication modules for supporting various wireless communication methods, such as a WiFi module, a wireless broadband (Wibro) module, a global system for mobile communication (GSM), a code division multiple access (CDMA), a wideband code division multiple access (WCDMA), universal mobile telecommunications system (UMTS), a time division multiple access (TDMA), a long term evolution (LTE), and the like.

The wireless communication module may include a wireless communication interface including an antenna for transmitting a signal and a transmitter. The wireless communication module may further include a signal conversion module for modulating a digital control signal output from the controller through an wireless communication interface into an analog type wireless signal under the control of the controller.

The wireless communication module may include a wireless communication interface including an antenna for receiving a signal and a receiver. The wireless communication module may further include a signal conversion module for demodulating the analog signal received through the wireless communication interface into a digital control signal.

At least one component may be added or deleted to correspond to the performance of the components of the vehicle illustrated in FIG. 1. In addition, it will be readily understood by those skilled in the art that the mutual position of the components may be changed corresponding to the performance or structure of the system.

Each component illustrated in FIG. 1 refers to software and/or hardware components such as Field Programmable Gate Array (FPGA) and Application Specific Integrated Circuit (ASIC).

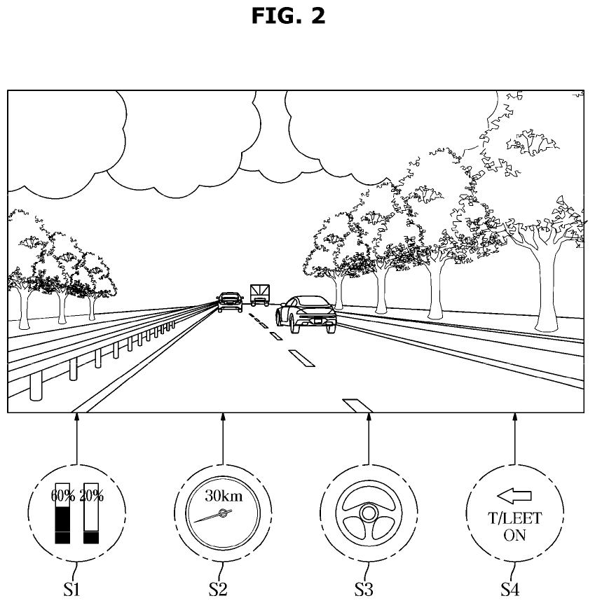

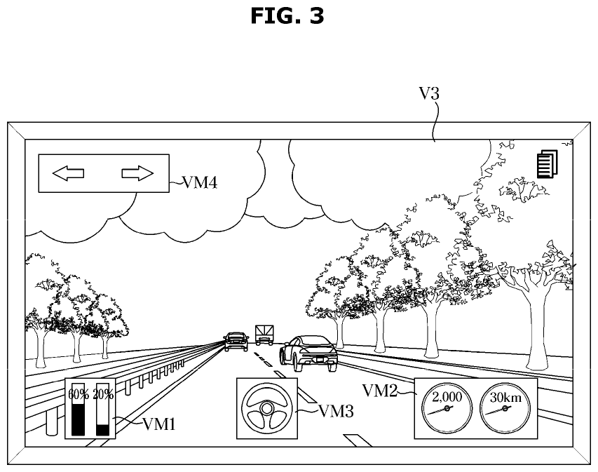

FIG. 2 is a diagram illustrating an operation of reflecting driving information in a vehicle driving image according to an exemplary embodiment of the present disclosure. FIG. 3 is a diagram illustrating driving information of a vehicle reflected in a driving image of the vehicle according to an exemplary embodiment of the present disclosure.

Referring to FIGS. 2 and 3, the driving information may include an operation state of a pedal effort 51, a vehicle speed S2, the rotation angle of a steering wheel S3, and a direction indicator S4.

On the other hand, the controller 130 can receive the following information from the vehicle through an in-vehicle CAN communication and a Hard Wire method.

The pedal effort S1 may mean a force for the driver to press an accelerator pedal, a brake pedal, a clutch, and the like. The controller 130 can display the pedal effort on the driving image using a figure that can be quantified, such as a gauge or bar to express the pedal effort from 0 to 100% (VM1). It also includes changing the gauge and bar colors when certain thresholds are reached.

The controller 130 may obtain the vehicle speed and RPM gauge S2 from the wheel speed sensor provided in the vehicle.

Wheel speed sensors are installed on each of the four front and rear wheels to detect the rotational speed of the wheel as a change in the line of magnetic force at the tone wheel and the sensor.

According to an exemplary embodiment, the controller 130 may express the vehicle speed and RPM gauge in the form of a number or the same gauge as the dashboard (VM2).

The controller 130 may output a driving image including a rotation angle of the steering wheel provided in the vehicle (VM3 and V3).

As described above, the controller may acquire the rotation angle of the steering wheel through the steering sensor provided in the control device 120 (V4).

The controller may display driving information including the operating state of the steering wheel in a form similar to the steering wheel provided in the vehicle on the driving image (VM3 and V3).

The controller may output the driving image including an operation state such as a direction indication of the vehicle (V4 and VM4).

On the other hand, the driving image and driving information shown in FIGS. 2 and 3 are only exemplary embodiments of the present disclosure and there is no limitation to the driving information that the controller can output to the driving image.

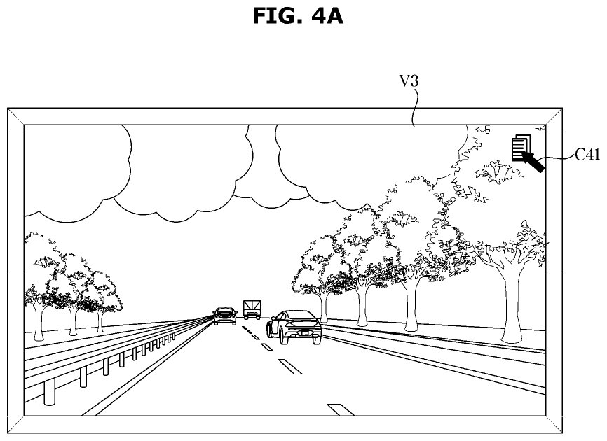

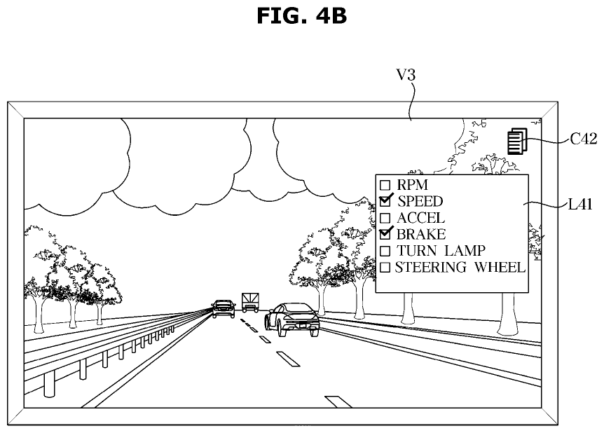

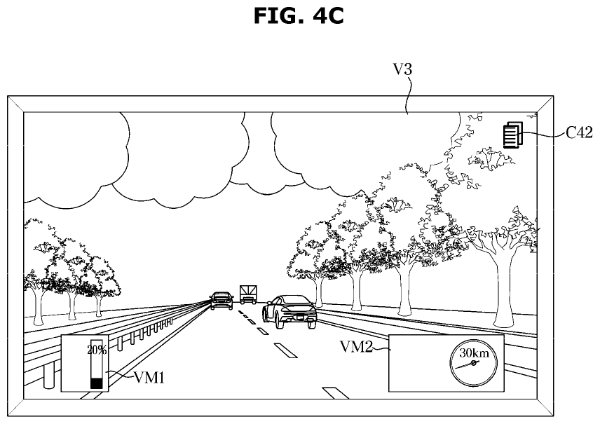

FIGS. 4A, 4B, and 4C are diagrams illustrating operations of selecting driving information displayed on a driving image according to an exemplary embodiment.

As described above, the control device 120 may acquire a plurality of driving elements of the vehicle.

The controller 130 may control to display driving information of the vehicle including at least one of the plurality of driving elements on the driving image based on a user's command input through an input unit.

Specifically, referring to FIG. 4A, a user may select a menu tab C41 provided in a driving image through an input unit. According to an embodiment, the menu tab may be formed as a User Interface (UI) in the form of an icon of a driving image.

Referring to FIG. 4B, when the user selects the menu tab, the controller 130 may output driving information L41 to the driving image.

In FIG. 4B, as the driving information that the controller 130 can output, a Revolutions-Per-Minute (RPM), vehicle speed (SPEED), pedal effort (ACCEL, BRAKE), a turn signal (TURN LAMP), and a steering wheel rotation angle (STEERING WHEEL) may be represented.

The user may select at least one of the driving information through the input unit. In FIG. 4B, the user determines the vehicle speed SPEED and the pedal effort of the brake pedal BRAKE.

Referring to FIG. 4C, driving information selected by the user in FIG. 4B may be output to the driving image. That is, the controller 130 may output all driving information shown in FIG. 4B to the driving image, but may selectively output only driving information selected by the user. FIG. 4C shows that the vehicle speed SPEED and the pedal effort of the brake pedal BRAKE selected by user in FIG. 4B are output to the driving image (VM41, VM42, VM43).

The operations shown in FIGS. 4A, 4B, and 4C are only exemplary embodiments of the present disclosure; however, there is no restriction on the type of driving information and there is no restriction on the operation of the user to select at least one of the driving information to output to the driving image.

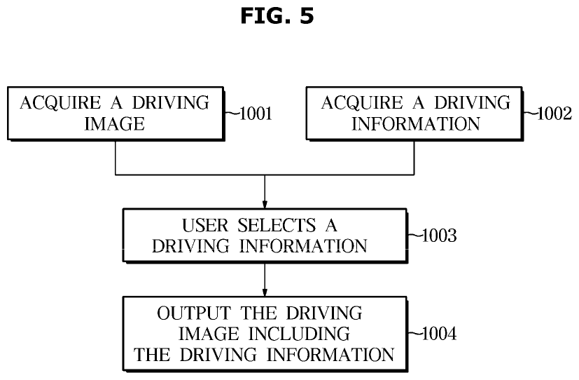

FIG. 5 is a flowchart according to an exemplary embodiment of the present disclosure.

Referring to FIG. 5, a vehicle may acquire driving images and driving information (1001 and 1002). As described above, the driving information may include RPM, vehicle speed, pedal effort, turn signal, and steering wheel rotation angle.

The user may select at least one of the corresponding driving information (1003). The controller may output the driving image acquired by the vehicle together with the driving information selected by the user (1004).

The vehicle, the control method of the vehicle, and the image module according to an exemplary embodiment may provide a driving image including driving information of the vehicle to determine a smooth driving situation.

The disclosed embodiments may be embodied in the form of a recording medium storing instructions executable by a computer. The instructions may be stored in the form of program code and, when executed by a processor, may generate a program module to perform the operations of the disclosed embodiments. The recording medium may be embodied as a computer-readable recording medium.

The computer-readable recording medium includes all kinds of recording media in which instructions which can be decoded by a computer are stored, for example, a Read Only Memory (ROM), a Random Access Memory (RAM), a magnetic tape, a magnetic disk, a flash memory, an optical data storage device, and the like.

Although exemplary embodiments of the present disclosure have been described for illustrative purposes, those skilled in the art will appreciate that various modifications, additions and substitutions are possible, without departing from the scope and spirit of the disclosure. Therefore, exemplary embodiments of the present disclosure have not been described for limiting purposes.

What is claimed is:

1. A vehicle comprising:
a camera configured to acquire a driving image of the vehicle;
a control device; and
a controller configured to output the driving image by reflecting driving information of the vehicle derived based on a control situation of the control device to the driving image acquired by the camera.

2. The vehicle according to claim 1, wherein the control device is configured to acquire a plurality of driving elements of the vehicle, and wherein the controller is configured to display the driving information, which comprises at least one of the plurality of driving elements, on the driving image based on a user's command input.

3. The vehicle according to claim 1, wherein the control device comprises a steering wheel of the vehicle,
wherein the controller is configured to output the driving image comprising a rotation angle of the steering wheel.

4. The vehicle according to claim 1, wherein the control device comprises a pedal of the vehicle,
wherein the controller is configured to output the driving image comprising a pedal effort of the pedal.

5. The vehicle according to claim 1, wherein the controller is configured to output the driving image comprising a speed of the vehicle derived based on a wheel speed of the vehicle.

6. The vehicle according to claim 1, wherein the controller is configured to output the driving image comprising an operation state, and
wherein the operation state includes a direction indication of the vehicle.

7. A control method of a vehicle, comprising:
acquiring a driving image of the vehicle; and
outputting the driving image by reflecting driving information of the vehicle to the driving image.

8. The control method according to claim 7, further comprising:
acquiring a plurality of driving elements of the vehicle; and
determining at least one of the plurality of driving elements based on a user's command input.

9. The control method according to claim 7, wherein, in the outputting, the driving image comprising a rotation angle of the steering wheel is output.

10. The control method according to claim 7, wherein, in the outputting, the driving image comprising a pedal effort of the pedal is output.

11. The control method according to claim 7, wherein, in the outputting, the driving image comprising a speed of the vehicle derived based on a wheel speed of the vehicle is output.

12. The control method according to claim 7, wherein, in the outputting, the driving image comprising an operation state is output, and
wherein the operation state includes a direction indication of the vehicle.
